(19) United States
(12) Patent Application Publication
(10) Pub. No.: US 2017/0098258 A1
(43) Pub. Date: Apr. 6, 2017

(54) SYSTEM AND METHOD FOR MANAGING INVOICE INFORMATION

(71) Applicant: CHOICE ENERGY SERVICES, Houston, TX (US)

(72) Inventor: Kivanc Dikmen, Houston, TX (US)

(21) Appl. No.: 14/872,801

(22) Filed: Oct. 1, 2015

(51) Int. Cl. G06Q 30/04

(52) U.S. Cl. CPC G06Q 30/04

(57) ABSTRACT

The present invention is related to a system and method for managing invoice information. The system and method may involve an invoice management server that is configured to prepare invoice information, process invoice information, and store invoice information. In the preparing step, the invoice management server may communicate with a data collecting server to receive aggregated and standardized invoice information of a customer from the data collecting server. In the processing step, the invoice management server may process prepared invoice information into categories of information that contain the customer's energy spending summary, invoice information based on the customer's locations, invoice information based on the customer's accounts, and actual invoice information and virtual invoice information. In the storing step, the invoice management server may store prepared invoice information, processed information, information from vendor servers, and documents uploaded by the customer.

### FILED OF THE INVENTION

The present invention relates to a system and method for managing invoice information, and particularly to a system and method for managing invoice information that prepares, processes, and stores the invoice information.

### BACKGROUND OF THE INVENTION

Organizations such as businesses typically receive large volumes of vendor invoices such as utility bills. Traditionally, organizations have to manually review and pay those invoices, and such processes are fraught with problems. One problem is the failure to get the invoices through the organization's review, approval, and accounts-payable process in time to avoid late fees and potentially service shut-off. Another problem is the inability of the organization to carefully review the invoices for accuracy, e.g., comparing current charges to those of prior invoices, because such a review would be too costly and/or cumbersome, resulting in invoicing errors that may never be found. Yet another problem is the unwillingness of employees of the organization, e.g., store and branch managers, to give the review process a high priority or to put much time into the review process because the review is considered to be tedious, resulting in invoices that are unduly held up or not properly reviewed. Yet another problem is the necessity of staff to review the invoices, resulting in a labor intensive and therefore costly review process. While there are services and electronic systems that have tried to resolve the above-identified problems, none of them are effective.

Accordingly, there remains a need for an electronic system and computer-implemented method that is improved over what is known in the art and that can resolve deficiencies of existing services and electronic systems.

### SUMMARY OF THE INVENTION

In accordance with a preferred embodiment of the present invention, a system for managing invoice information is contemplated. The system may comprise an invoice management server comprising a processor and a memory storing a series of instructions, wherein the processor is configured to execute the series of instructions to:

prepare invoice information by instructing the invoice management server to communicate with a data collecting server to receive aggregated and standardized invoice information of a customer from the data collecting server, the data collecting server aggregates and standardizes invoice information of the customer from multiple vendor servers;

process invoice information by instructing the invoice management server to process prepared invoice information into categories of information, wherein the categories of information include a first category of information containing the customer's energy spending summary, a second category of information containing invoice information based on the customer's locations, a third category of information containing invoice information based on the customer's accounts, and a fourth category of information containing actual invoice information and virtual invoice information, wherein the virtual invoice information contain information extracted from the actual invoice information and the extracted information include itemized charges; and

store invoice information by instructing the invoice management server to store prepared invoice information, processed information, information from vendor servers, and documents uploaded by the customer.

In one variation of the system, the customer's energy spending summary is created based on energy type, vendor, and historical spending.

In one variation of the system, the customer's energy spending summary created based on energy type include multiple pieces of information that comprise an energy type piece of information. The energy type piece of information is created before remaining pieces of information in the multiple pieces of information.

In one variation of the system, the customer's energy spending summary created based on vendor includes multiple pieces of information that comprise a list of vendors. The list of vendors is created before remaining pieces of information in the multiple pieces of information.

In one variation of the system, the customer's energy spending summary created based on historical spending include multiple pieces of information that comprise amounts the customer has paid, one or more energy type being paid, period of time the customer has been paying, and frequency of the payment. The one or more energy type being paid piece of information or the period of time piece of information is created before remaining pieces of information in the multiple pieces of information.

In one variation of the system, the second category of information include multiple pieces of information that comprise a list of all the customer's locations. The list of all the customer's locations is created before remaining pieces of information in the multiple pieces of information.

In one variation of the system, the third category of information include multiple pieces of information that comprise a list of all the customer's accounts. The list of all the customer's accounts is created before remaining pieces of information in the multiple pieces of information.

In one variation of the system, the itemized charges are individual charges obtained by breaking down a total invoice amount in the actual invoice information.

In one variation of the system, the processor is configured to execute the series of instructions to further measure each itemized charge in a performance metric. The performance metric is customer-entered.

In one variation of the system, same virtual invoice information are extracted from actual invoices of all the customer's locations.

In one variation of the system, the extracted information further includes meter reading information and performance information. The performance information includes month-to-month comparison or year-to-year comparison.

In one variation of the system, the processor is configured to execute the series of instructions to further prepare information needed for energy star certification and to apply for energy star certification for each of the customer's locations.

In one variation of the system, the processor is configured to execute the series of instructions to further audit a customer's energy invoice based on meter readings and energy rates.

In accordance with another preferred embodiment of the present invention, a method for managing invoice information is contemplated. The method may comprise preparing invoice information by aggregating and standardizing invoice information of a customer from multiple vendor servers; processing invoice information by process prepared invoice information into categories of information, wherein the categories of information include a first category of information containing the customer's energy spending summary, a second category of information containing invoice information based on the customer's locations, a third category of information containing invoice information based on the customer's accounts, and a fourth category of information containing actual invoice information and virtual invoice information, wherein the virtual invoice information contains information extracted from the actual invoice information and the extracted information includes itemized charges; and storing invoice information by storing prepared invoice information, processed information, information from vendor servers, and documents uploaded by the customer.

In one variation of the method, the customer's energy spending summary is created based on energy type, vendor, and historical spending.

In one variation of the method, the customer's energy spending summary created based on energy type include multiple pieces of information that comprise an energy type piece of information.

In one variation of the method, the energy type piece of information is created before remaining pieces of information in the multiple pieces of information.

In one variation of the method, the customer's energy spending summary created based on vendor include multiple pieces of information that comprise a list of vendors.

In one variation of the method, the list of vendors is created before remaining pieces of information in the multiple pieces of information.

In one variation of the method, the customer's energy spending summary created based on historical spending include multiple pieces of information that comprise amounts the customer has paid, one or more energy type being paid, period of time the customer has been paying, and frequency of the payment.

In one variation of the method, the one or more energy type being paid piece of information or the period of time piece of information is created before remaining pieces of information in the multiple pieces of information.

In one variation of the method, the second category of information include multiple pieces of information that comprise a list of all the customer's locations.

In one variation of the method, the list of all the customer's locations is created before remaining pieces of information in the multiple pieces of information.

In one variation of the method, the third category of information include multiple pieces of information that comprise a list of all the customer's accounts.

In one variation of the method, the list of all the customer's accounts is created before remaining pieces of information in in the multiple pieces of information.

In one variation of the method, the itemized charges are individual charges obtained by breaking down a total invoice amount in the actual invoice information.

In one variation of the method, the method further comprises measuring each itemized charge in a performance metric.

In one variation of the method, the performance metric is customer-entered.

In one variation of the method, same virtual invoice information are extracted from actual invoices of all the customer's locations.

In one variation of the method, the extracted information further include meter reading information and performance information.

In one variation of the method, the performance information include month-to-month comparison or year-to-year comparison.

In one variation of the method, the method further comprises preparing information needed for energy star certification and applying for energy star certification for each of the customer's locations.

In one variation of the method, the method further comprises auditing a customer's energy invoice based on meter readings and energy rates.

Counterpart computer-readable medium embodiments would be understood from the above and the overall disclosure. Also, broader, narrower, or different combinations of the described features are contemplated, such that, for example features can be removed or added in a broadening or narrowing way.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 depicts an illustrative computer-implemented method for managing invoice information.

FIG. 2 depicts an illustrative invoice management server communicating with a data collecting server and multiple vendor servers.

FIG. 3 depicts an illustrative data collecting server aggregating invoice information from multiple vendor servers.

FIG. 4 depicts one embodiment of the step of processing invoice information.

FIG. 5 depicts the invoice management server processing prepared information to create a first category of information.

FIG. 6 depicts an illustrative customer's energy spending summary created based on energy type.

FIG. 7 depicts an illustrative customer's energy spending summary created based on vendor.

FIG. 8 depicts an illustrative customer's energy spending summary created based on historical spending.

FIG. 9 depicts an example screen displaying a customer's energy spending summary by energy type, vendor, and historical spending.

FIG. 10 depicts the invoice management server processing prepared information to create a second category of information.

FIG. 11a-11c depict illustrative pieces of information included in the second category of information.

FIG. 12 depicts the invoice management server processing prepared information to create a third category of information.

FIG. 13 depicts illustrative pieces of information included in the third category of information.

FIG. 14 depicts the invoice management server processing prepared information to create a fourth category of information.

FIG. 15a-15c depict illustrative pieces of information included in the fourth category of information.

FIG. 16 depicts one embodiment of the step of processing invoice information.

FIG. 17 depicts an example screen showing a customer's energy service contracts, and customer uploaded documents.

FIG. 18 depicts exemplary hardware and software components of a computer employed in in embodiments of the present invention.

### DETAILED DESCRIPTION OF THE INVENTION

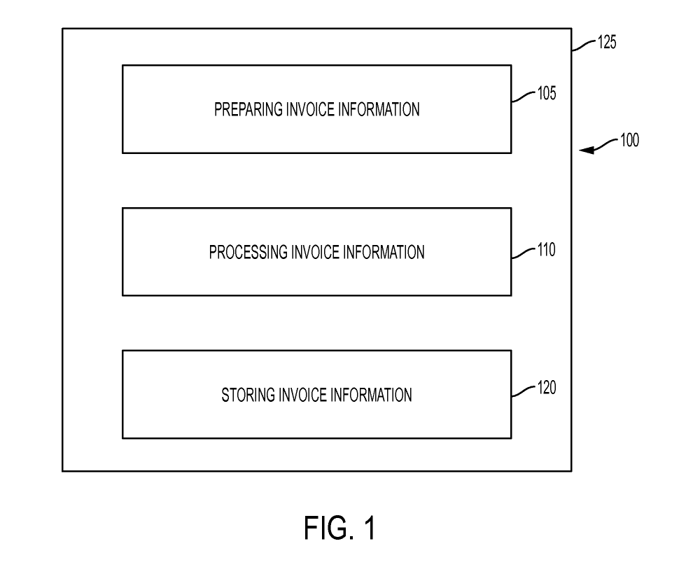

Referring to FIG. 1, one embodiment of the computer-implemented method for managing invoice information 100 is illustrated. The method 100 may comprise preparing invoice information 105, processing invoice information 110, and storing invoice information 120. The computer on which the method is implemented may be an invoice management server 125. The invoice management server 125 may also be a bill management server, a utility data management server, or other similar server or computer. The invoice management server 125 may be a counterpart system of the computer-implemented method 100.

Invoice information may include any information contained in commodity invoices. Commodity invoices may include utility invoices such as electric invoices, gas invoices, water invoices, oil invoices, or any combinations thereof. Information contained in each of those utility invoices may encompass the name, account number, and address of the customer, the name, payment mailing address, and contact information of the energy supplier, the total amount due, the supply charges, the delivery charges, the starting date and the ending date from which usage is measured, the amount of energy used from the starting date to the ending date, the amount of the last payment received, the date on which the last payment is received, the remaining balance from the last invoice after applying the last payment to the customer's account, average daily, monthly, or yearly usage, insurances, taxes, other fees charged by the supplier and/or government, or any combinations thereof. Commodity invoices may likewise include other invoices such as waste invoices, cable invoices, satellite invoices, telephone invoices, Internet invoices, other invoices a company or individual may incur during the regular course of business, or any combinations thereof. Information contained in each of those commodity invoices may be similar to the information discussed above with names, dates, charges, taxes, and other fees corresponding to the business and/or transaction involved in those commodity invoices.

Invoice information may also include any information contained in other periodic invoices such as invoices from routine building maintenance and repairs, invoices from regular inventory purchases, invoices from services outsourced on a permanent basis, etc. Invoice information may further include any information contained in an one-time invoice from any vendors. Information contained in each of those periodic and one-time invoices may be similar to the information discussed above with names, dates, charges, taxes, and other fees corresponding to the business and/or transaction involved in those invoices.

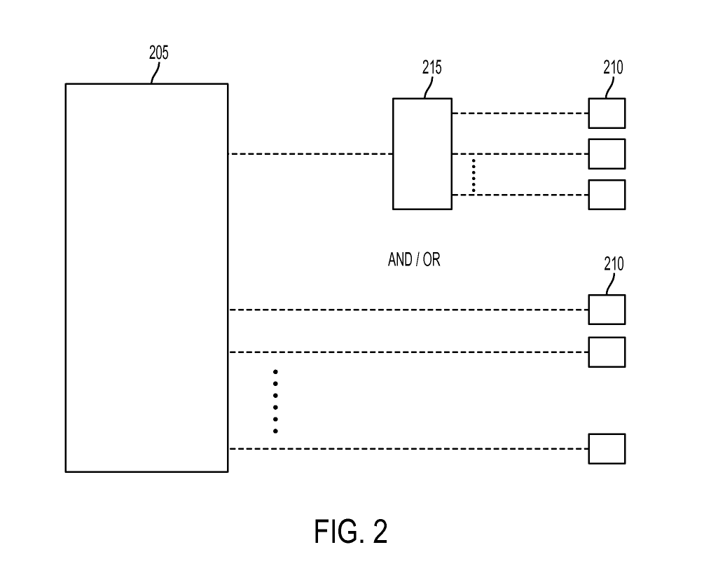

Referring to FIG. 2, one embodiment of the step of preparing invoice information 200 is illustrated. In this embodiment, the invoice management server 205 may communicate with a data collecting server 215 that aggregates and standardizes invoice information from multiple vendor servers 210 to receive invoice information. The data collecting server 215 may communicate with multiple vendor servers 210 to retrieve invoice information stored in multiple vendor servers 210. Multiple vendor servers 210 may also be vendor databases where invoice information are stored. When multiple vendor servers 210 are vendor databases, each of the vendor databases may or may not be controlled by its respective vendor server. When a vendor database is controlled by a vendor server, the data collecting server 215 communicates with the vendor server to obtain invoice information stored in the vendor database. When a vendor database is not controlled by a vendor server, the data collecting server 215 may communicate directly with the vendor database to obtain invoice information without communicating with a vendor server. When a vendor database is not controlled by a vendor server, the vendor database may also be managed by a database server or third-party server that is a distinct separate device from multiple vendor servers 210 and is independently controlled and operated by a party different from the vendor. In this case, the data collecting server 215 may communicate with the third-party server to obtain invoice information stored in the vendor database. The obtained invoice information may be standardized by the data collecting server 215 before transmitting to the invoice management server 205. The data collecting server 215, for example, may be a server or system developed by an external third party, e.g., Urjanet. The utilization of a data collecting server 215 may help relax hardware and software requirements of the invoice management server 205 because the aggregating and standardizing procedures are performed on the data collecting server 215. The invoice management server 205 also only needs to communicate with one server via one communication path as opposed to multiple servers via multiple communication paths. As such, the invoice management server 205 may operate with reduced processing power and memory and may be equipped with a moderate central processing unit and less memory. Reduction in processing power also leads to reduction in power consumption which in turns saves electricity.

Still referring to FIG. 2, the invoice management server 205 may also communicate directly with multiple vendor servers 210 to aggregate and standardize invoice information without employing a data collecting server. In this case, part of the invoice management server 205 may be configured to perform functions of the data collecting server 215. Such a configuration may save the owner of the invoice management server 205 from paying a fee to the company developed the data collecting server 215 or the licensee of the technology for using the server and its services, reduce additional delay caused the data collecting server 215, and eliminate the space occupied by the data collecting server 215 to save room for the company developed the data collecting server 215 or the licensee of the technology. The invoice management server 205 may standardize each invoice information the moment it receives the invoice information. The invoice management server 205 may also postpone standardization until all the invoice information are received.

In some embodiments, the invoice management server 205 may collect some invoice information from some vendor servers via the data collecting server 215 and some invoice information from some other vendor servers without the data collecting server 215.

Aggregation may refer to a collection of, or collecting, invoice information from multiple vendor servers. In one embodiment, invoice information collected from a vendor server is stored individually in the data collecting server or the invoice management server and is separated from other invoice information collected from other vendor server(s). Any additional invoice information collected subsequently from that vendor server is added to or stored with the previous collected invoice information from that vendor server. As such, the collection of invoice information may comprise groups of invoice information wherein the groups of invoice information are independent of each other and each group of invoice information is associated with or identified by its respective vendor server or vendor. In another embodiment, invoice information collected from a vendor server may be merged with invoice information collected from another vendor server. Any additional invoice information collected subsequently from any of the vendor servers may be further added to or stored with the previous collected invoice information from any of the vendor servers. As such, the collection of invoice information may comprise one group of invoice information wherein the group of invoice information is a compilation of all the invoice information from all the vendor servers and the compilation is based on the order in which invoice information is received. The compilation is formed without dividing the collected invoice information based on the vendor server from which invoice information is collected.

Standardization, in one embodiment, may refer to that all the invoice information are converted to the same format. Standardization, in another embodiment, may refer to that the invoice information is converted into a format that can handled by the invoice management server, such as capable of being processed and/or stored by the invoice management server as disclosed in FIG. 1. As such, invoice information may not need to be converted into the same format (or may be converted into a different format) as long as the converted format can be handled by the invoice management server. In some embodiments, the standardization procedure may be omitted if necessary and the invoice management server may be configured to receive and handle raw data or raw invoice information. In some embodiments, the standardization procedure may occur in the processing step or the storing step. In some embodiments, additional standardization procedures may be employed in the processing step and/or storing step.

While a server or system developed by an external third party can aggregate and standardize invoice information, some of the features of the aggregation and standardization procedures disclosed in this application may not be implemented on that server or system and may be employed to improve that server or system.

The invoice management server may be owned or operated by an entity different from the vendors that own or operate the vendor servers and different from the customers of the entity. The entity, the vendors, and the customers all operate their businesses independently of each other and do not have control over each other's business or servers. The entity may be any entity that helps customers manage their invoices without paying their invoices. The entity may be an energy broker. The vendors may be any vendors that sell energy, services, or products to the customers. Each of these vendors, for example, may be an energy supplier, a service provider, or a merchandise seller. An energy supplier may be regulated or deregulated. The customers may be any companies that engaged the service of the entity. The entity, the vendors, and the customers referred to may also be individuals.

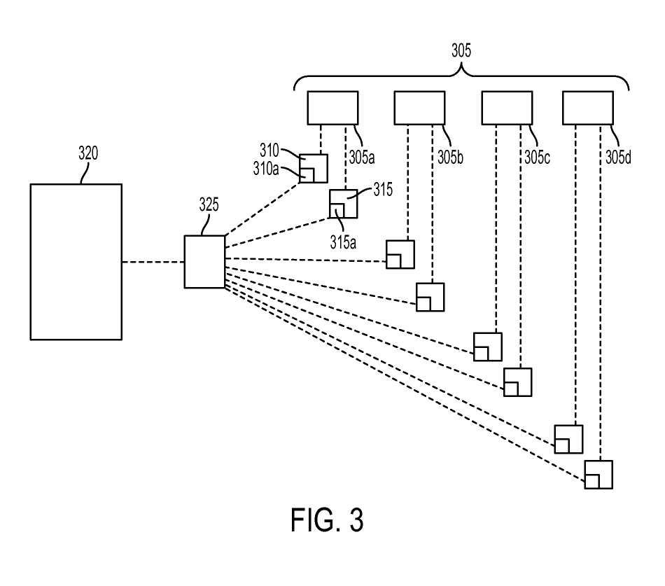

Referring to FIG. 3, a customer 305 may have one or more locations 305a-305d, e.g., offices, warehouses, stations etc., where each location receives one or more invoices from one or more vendors 310, 315. Each location may receive the one or more invoices from the one or more vendors 310, 315 electronically or physically. In the preparation step, the invoice management server 320 may communicate with the data collecting server 325 to request invoice information for one, some, or all of the customer's locations 305a-305d. The requested invoice information may be invoice information from the most recent invoice, invoice information for specific periods of time, or all invoice information from the earliest date that may be obtained from the vendor servers 310a, 315a. In one example, the data collecting server 325 may have the requested invoice information already stored in its storage medium and may be transmitted to the invoice management server 320 immediately upon request. The data collecting server 325 may be configured to periodically communicate with the vendor servers 310a, 315a to obtain most recent invoice information. In another example, the data collecting server 325 may not have the requested invoice information available in its storage medium and may communicate with one or more vendors servers 310a, 315a to obtain the requested invoice information upon request. After the obtaining the requested invoice information, the data collecting server 325 may transmit the requested invoice information to the invoice management server 320. Depending on the request by the invoice management server 320, the data collecting server 325 communicates with the appropriate vendor servers to obtain the requested invoice information. The vendor servers 310a, 315a are where the vendors generate and/or store the invoices or invoice information contained in the invoices. In both examples, the invoice management server 320 stores the requested invoice information in its storage medium upon receipt, which may be the storing step disclosed in FIG. 1. The invoice management server 320 may perform like the data collecting server 325 described in this paragraph if it is configured to perform as such.

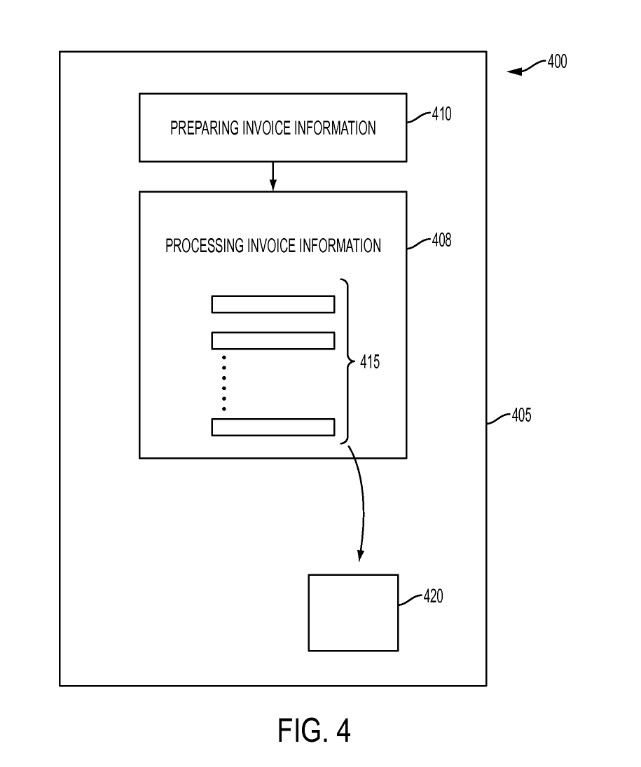

Referring to FIG. 4, one embodiment of the step of processing invoice information 400 is illustrated. In this embodiment, the invoice management server 405 may process 408 invoice information prepared by the preparation step 410 to create categories of information 415. The created categories of information may be saved in a database 420 of the invoice management server 405 and be displayed on a monitor upon access. The monitor may be the monitor of the customer's computer if it is the customer's computer that accesses the invoice management server to view these categories of information. The monitor may also be the monitor of the invoice management server if the invoice management server has a monitor. The created categories of information may be displayed as a chart, and the chart may be a table, graph, diagram, pie chart, or other similar chart for comparison and ease of reading. The chart may be grouped by energy type, vendor, customer's locations, date, or energy usage, and be sorted in an ascending, descending, or alphabetical order. A copy of each created category of information, or a copy of each information in each category may be saved to the customer's computer or withdrawn from the invoice management server.

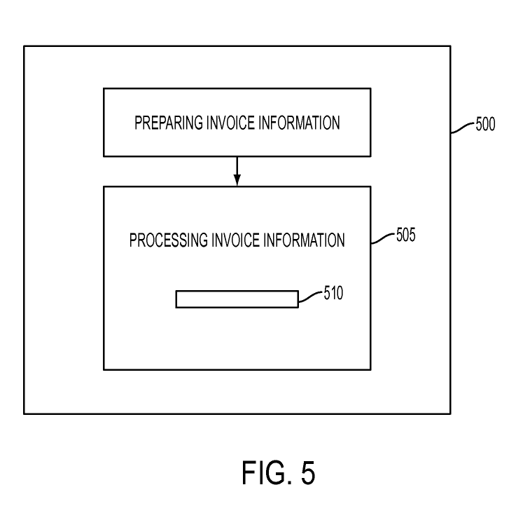

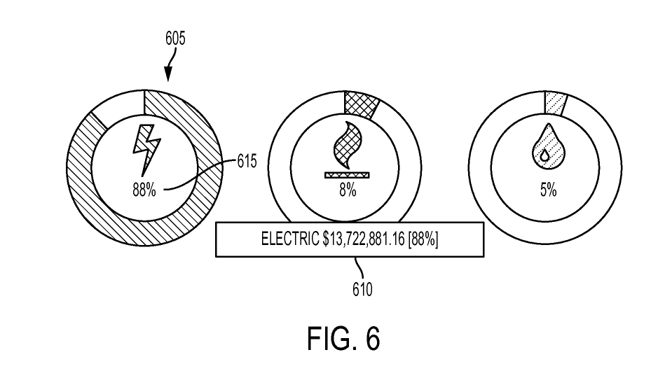

Referring to FIG. 5, the invoice management server 500 may process 505 prepared information to create a first category of information 510 that contains a customer's energy spending summary. This category of information 510 may be created based on energy type, vendor, and historical spending. When the energy spending summary is created based on energy type, the energy spending summary may include, as shown in FIG. 6, multiple pieces of information such as a plurality of energy types 605, a total invoiced amount for each energy type 610, a percentage of the total invoiced amount of an energy type to a total invoiced amount of all energy types 620. The total invoiced amount discussed here and below may be one of the following amounts. It may be a year-to-date amount invoiced by the vendor or an year-to-date amount paid by the customer. It may also be the total amount invoiced by the vendor from the first invoice (since the customer starts purchasing energy from that vendor) to the last invoice. It may also be the total amount paid by the customer from the first payment (since the customer starts purchasing energy from that vendor) to the last payment. The plurality of energy types may include electricity, water, gas, and oil. During the creation based on energy type, the energy type piece of information is created from the prepared information prior to other pieces of information. The other pieces of information or the remaining pieces of information are subsequently created from the prepared information according to the energy type piece of information. For example, when the created energy type piece of information encompasses electricity and gas, the remaining pieces of information are created for each energy type.

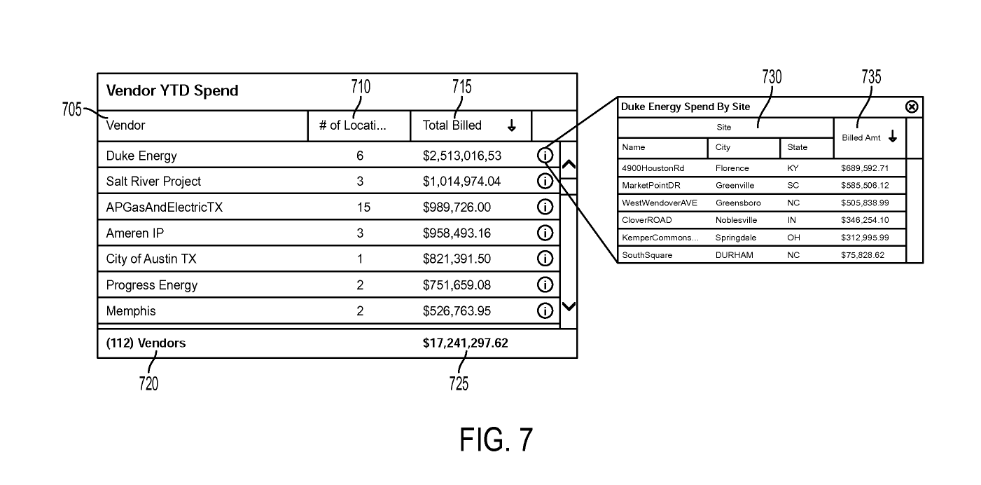

When the energy spending summary is created based on vendor, the energy spending summary may include, as shown in FIG. 7, multiple pieces of information such as a list of vendors 705, number of customer's locations purchasing energy from each vendor in the list of vendors 710, a total invoiced amount by each vendor 715, a total number of vendors 720, and a total invoiced amount by the total number of vendors 725. For each vendor in the list of vendors 705, the summary may further include addresses of the customer's locations associated with that vendor 730 and a total invoiced amount for each of those customer locations 735. During the creation based on vendor, the list of vendor is created from the prepared information prior to other pieces of information. The other pieces of information or the remaining pieces of information are subsequently created from the prepared information according to the list of vendor. For example, when the created list of vendors encompasses Vendor A and Vendor B, the remaining pieces of information are created for each vendor.

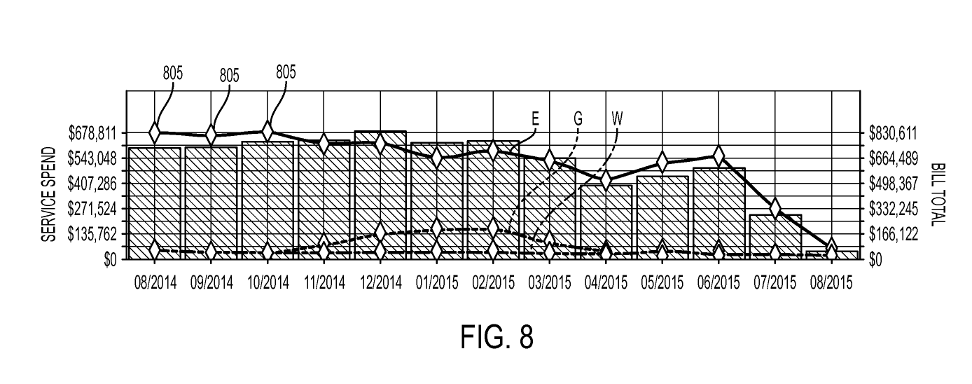

When the energy spending summary is created based on historical spending, the energy spending summary may include, as shown in FIG. 8, the amounts 805 the customer has paid for one or more energy type over a period of time on a periodic basis. This is created by multiple pieces of information such as the amounts the customer has paid, the one or more energy type being paid, the period of time the customer has been paying, and the frequency of payment. Each of the amounts 805 may represent the total amount the customer has paid for all of the customer's locations. The period of time may be the past 6 months, the past 1 year, the past 5 years, or any other length. The period of time depicted in FIG. 8 is the past one year. The period of time may also start from a specific month or date and end on another specific month or date. Periodic basis or frequency of payment may be monthly basis, bimonthly basis, trimonthly basis, or any other basis. FIG. 8 depicts monthly basis. For example, a summary based on historical spending may include amounts that the customer has paid for electricity over the past 1 year on a monthly basis for all customer's locations (e.g., electricity invoice amount A for August 2014, electricity invoice amount B for September 2014, and so on for 1 year as shown by line E), amounts that the customer has paid for water over the past 1 year on a monthly basis for all customer's locations (e.g., water invoice amount C for August 2014, water invoice amount D for September 2014, and so on for one year as shown by line W), and amounts that the customer has paid for gas over the past one year on a monthly basis for all customer's (e.g., gas invoice amount E for August 2014, gas invoice amount F for September 2014, and so on for 1 year as shown by line G). The historical spending category may also include the total amount the customer has paid for each of the energy types from starting month or date to ending month or date of the period of time (e.g., total electricity invoice amount from August 2014 to August 2015). The historical spending category may include a service spend information that measures the spend for the individual commodity types per month. Each spend is represented on FIG. 8 by lines E, G, and W. It is the amount spent by month for each of the various types. The historical spending category may include a bill total information that measures the spend for the aggregate of the commodity types per month. The aggregate per month is represented by the monthly bars. It is the total of the amounts across all commodities for that month.

During the creation based historical spending, the one or more energy type being paid piece of information or the period of time piece of information is created from the prepared information prior to other pieces of information. The frequency of payment piece of information is created from the prepared information after those two pieces of information are created. The amount the customer had paid is created lastly from the prepared information.

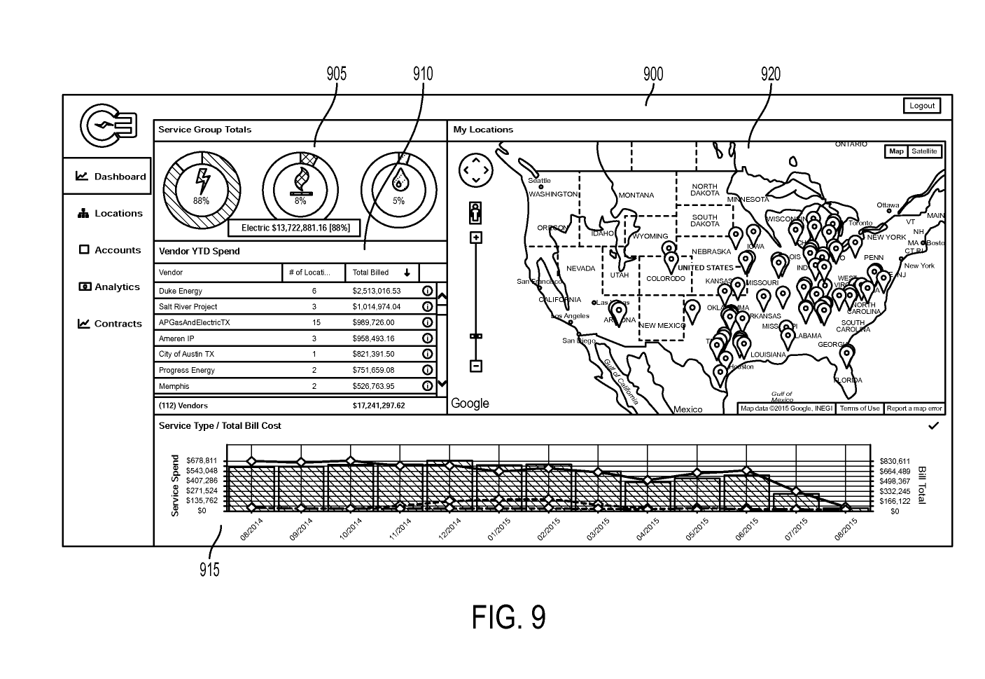

With a customer's energy spending summary created in the above manners, the invoice management server provides an overview of overall energy spending over a period of time and what percentage of customer's spending goes to which utility. FIG. 9 depicts an example screen 900 displaying the summary by energy type 905, vendor 910, and historical spending 915 when the first category of information is accessed. The screen 900 may further display customer's locations on a map 920 with addresses.

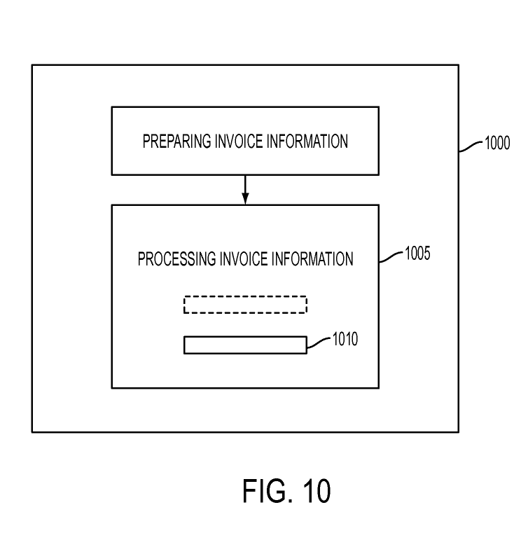

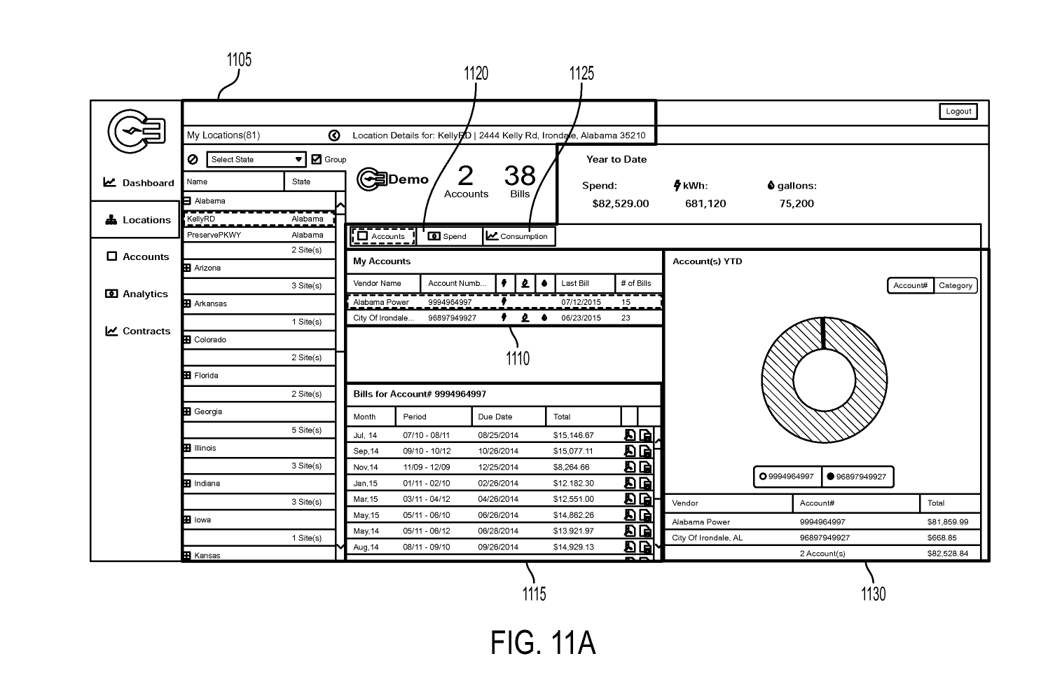

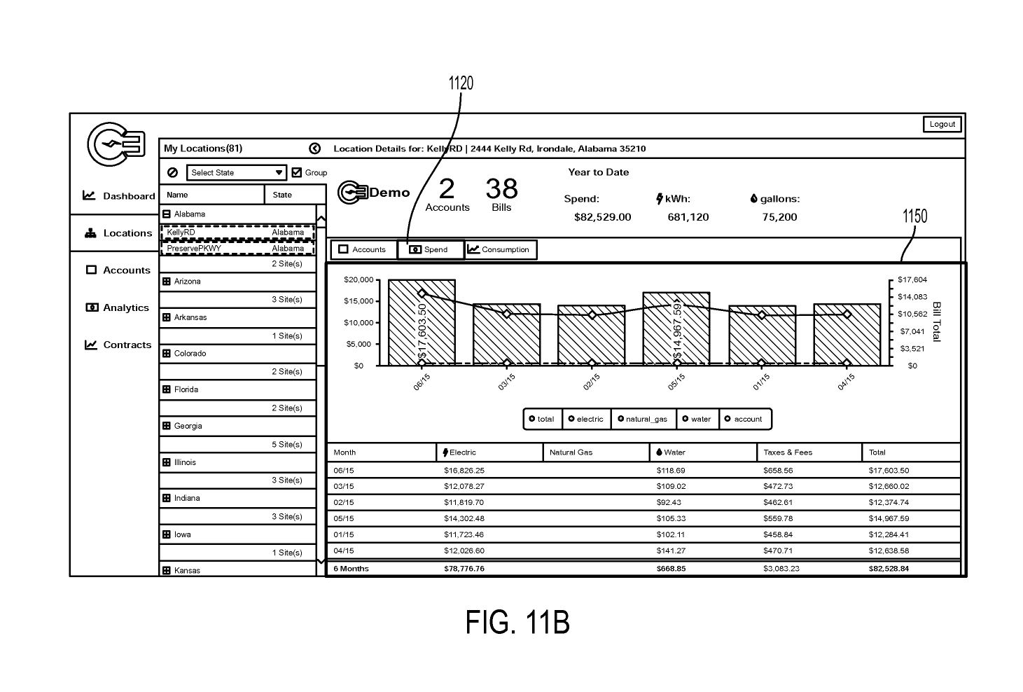

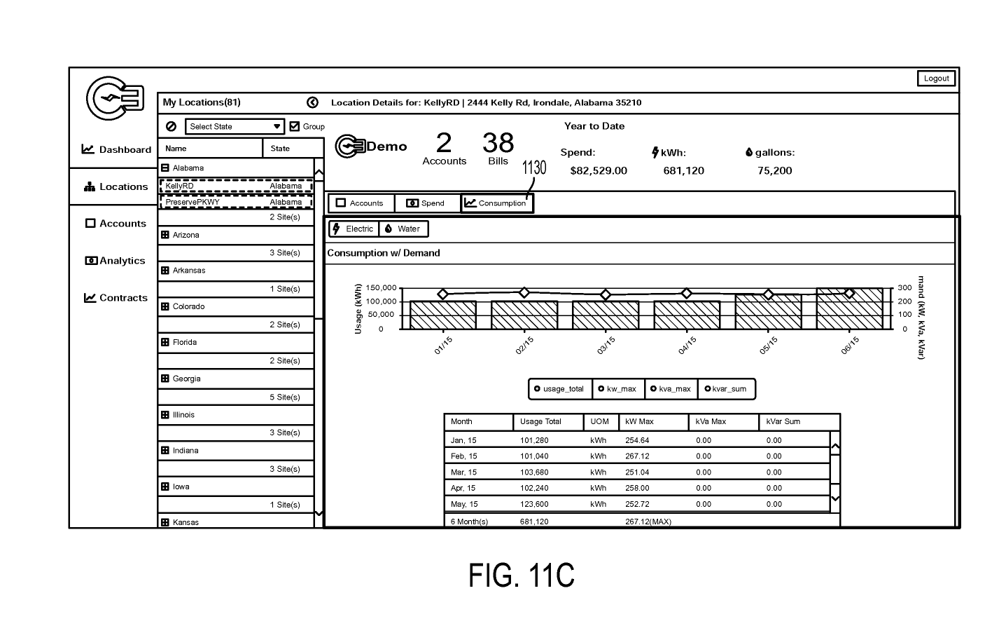

Referring to FIG. 10, the invoice management server 1000 may process 1005 prepared information to create a second category of information 1010 that contains invoice information based on the customer's locations. The second category of information 1010 may also be created by reviewing and retrieving relevant information from the third and/or fourth category of information described below. The second category of information 1010 may be likewise created by processing prepared information and by reviewing and retrieving relevant information from the third and/or fourth category of information. The second category of information may include, as shown in FIG. 11a, multiple pieces of information such as a list of all the customer's locations organized by state 1105, customer's accounts in each location in the list 1110, invoices associated with each customer account 1115, spending of each energy for each customer location 1120, and consumption of each energy for each customer location 1125.

In the list of all customer's location organized by the state 1105, the list 1105 may include the number of customer's location in each state and the name and address of those customer locations. The number of accounts and the number of invoices for each of those customer locations may also be included. With respect to the customer's accounts in each location in the list 1110, each of those accounts may include a vendor name, an account number, type of energy purchased, and number of invoices received. There may also be a comparison 1130 between a invoiced amount of an energy and a total invoiced amount of all energy for a customer location or between a invoiced amount of an energy at one customer location and another invoiced amount of another energy at another customer location. The invoiced amount and the total invoiced amount may be an amount for one or more service periods. For each customer location, a copy of the actual invoice for each energy type is also available for viewing and saving. As to the invoices associated with each customer account 1115, they may include past invoices with each indicating a service period, a due date, an invoiced amount, and other relevant information such as prior balance. In the spending for each energy for each customer location 1120, it may include, as shown in FIG. 11b, similar information 1150 as those shown in FIG. 9 except that the information 1150 is for only one customer location. It may also include amount paid for buying and delivering energy and amount paid for taxes and fees. Regarding the consumption for each energy for each customer location 1130, it may include, as shown in FIG. 11c energy usage on a monthly basis over a period of time. The period of time may be the past 6 months, the past 1 year, the past 5 years, or any other length. The period of time in FIG. 11c is the past 6 months. The period of time may also start from a specific month or date and end on another specific month or date.

During the creation of the second category of information, the list of all the customer's locations is created from the prepared information prior to other pieces of information. The other pieces of information or the remaining pieces of information are subsequently created from the prepared information according to the list of all the customer's locations. For example, when the created list of all the customer's locations encompasses Location A and Location B, the remaining pieces of information are created for each location. Each piece of information may also be created from the third category of information described below. Each piece of information may likewise be created from the prepared information and from the third category of information.

With the second category of information created in the above manner, the invoice management server provides easy look-up of all the customer's invoices from all its locations at one place organized by locations. Such information are very handy for regional managers or energy managers of the customer.

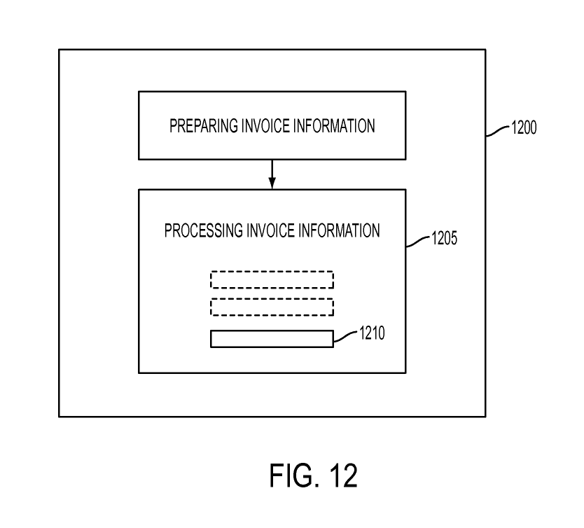

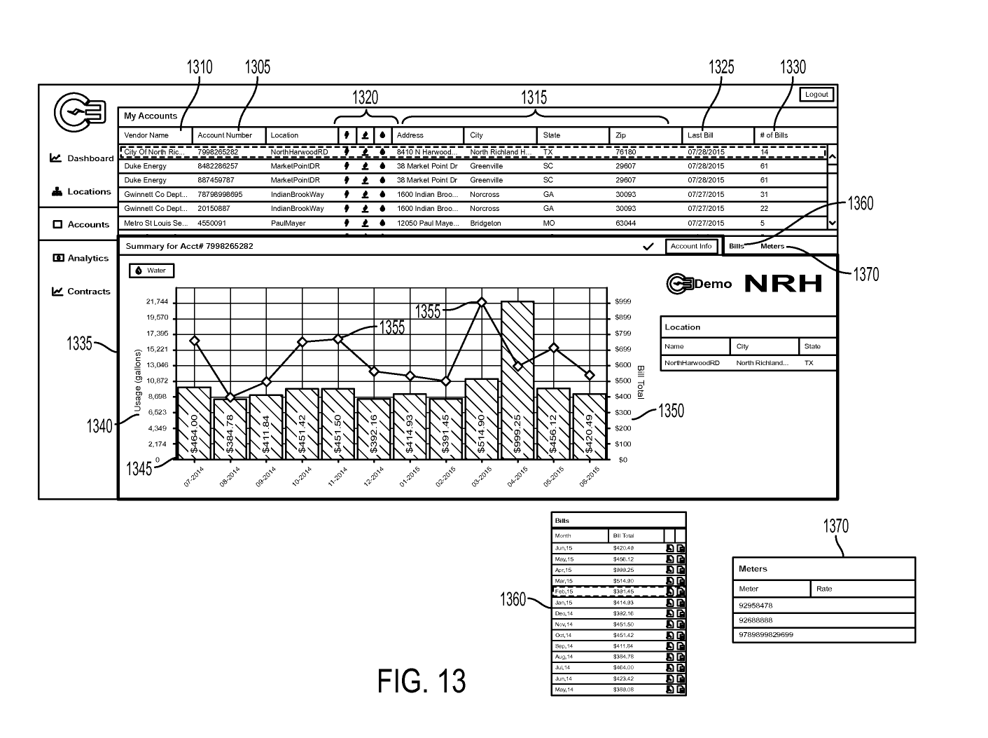

Referring to FIG. 12, the invoice management server 1200 may process 1205 prepared information to create a third category of information 1210 that contains invoice information based on the customer's accounts. The third category of information 1210 may also be created by reviewing and retrieving relevant information from the second and/or fourth category of information. The third category of information may likewise be created by processing prepared information and by reviewing and retrieving relevant information from the second and/or fourth category of information. The third category of information may include, as shown in FIG. 13, multiple pieces of information such as a list of all the customer's accounts 1305, vendor associated with each of all customer's accounts 1310, address of each of all customer's accounts 1315, type of energy associated with each of all customer's accounts 1320, date of last invoice received by each of all customer's accounts 1325, and number of invoices each of all customer's accounts has received 1330. The third category of information may also include a summary 1335 for each of all the customer's accounts that provides energy usage information 1340 and invoiced information 1350. The energy usage information 1340 may be monthly energy usage 1345 over a period of time such as one year. The invoiced information 1350 may include monthly invoices 1355 in that year. Other invoice issue frequencies and periods of time are also contemplated. An actual copy of each past invoice 1360 received by each of all customer's accounts may further be available in the third category of information for viewing and saving. Meter readings and energy rates 1370 for each of all customer's accounts may also be available. Meter readings and energy rates 1370 may be some parameters or the only parameters utilized by the invoice management server to audit a customer's energy invoice. Meter readings and energy rates 1370 may be information provided the customer or information obtained from a vendor server. The invoice management server may be configured with algorithms that calculate an estimated amount due based on the meter readings and energy rates and that compare the actual amount due in an energy invoice with the estimated amount. If there is a difference or substantial difference, the invoice management server may notify the customer of the discrepancy which could be caused by miscalculation, misreading, or misentering by the energy supplier and lead to overpayment by the customer. The notification may be in the form of an exception report. The same calculation and comparison may also be performed for energy usage. A meter reading may be an estimated or actual reading. An energy rate may be an energy supply rate, an energy delivery rate, or both. The invoice management server may further include other parameters set by the customer to notify the customer of such and other discrepancies. Those parameters may include maximum and minimum invoice amounts, maximum and minimum energy usage, and/or maximum and minimum meter readings on a monthly basis, an annually basis, or other basis.

During the creation of the third category of information, the list of all the customer's accounts is created from the prepared information prior to other pieces of information. The other pieces of information or the remaining pieces of information are subsequently created from the prepared information according to the list of the all the customer's accounts. For example, when the created listed of all the customer's accounts encompasses Account A and Account B, the remaining pieces of information are created for each location. Each piece of information may also be created from the two and/or fourth category of information (described below). Each piece of information may likewise be created from the prepared information and from the two and/or fourth category of information.

The third category of information target at accountants who need to allocate expenses at granular or account level. This category of information allows at glance validation of energy usage and spend for each of the customer's accounts.

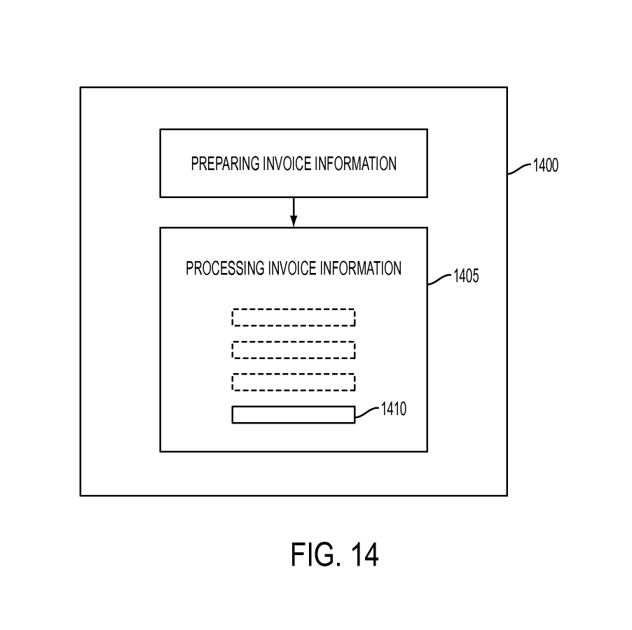

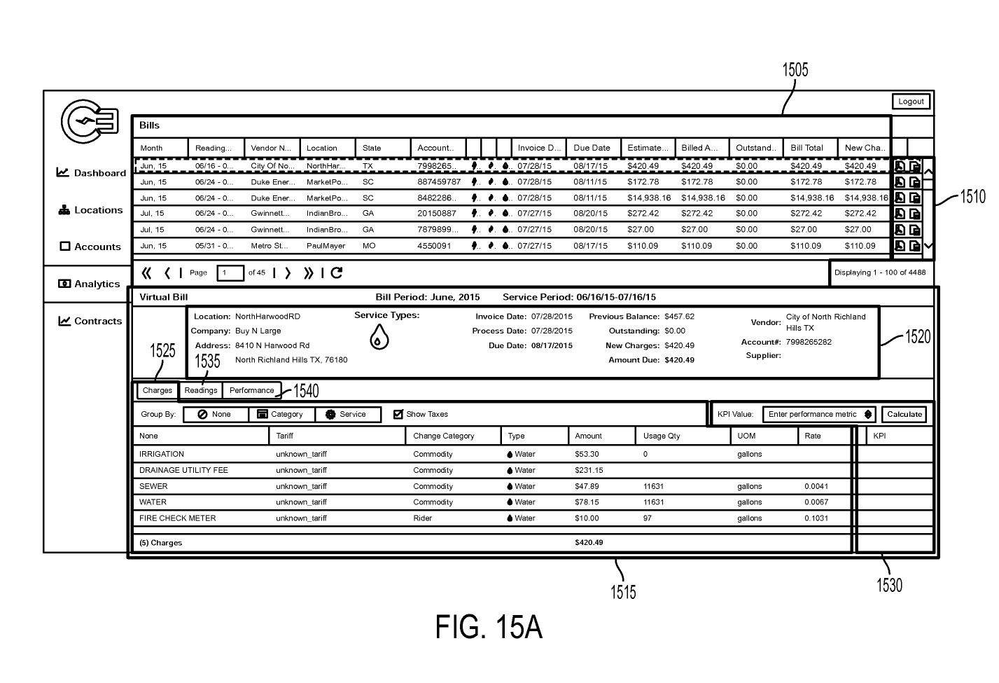

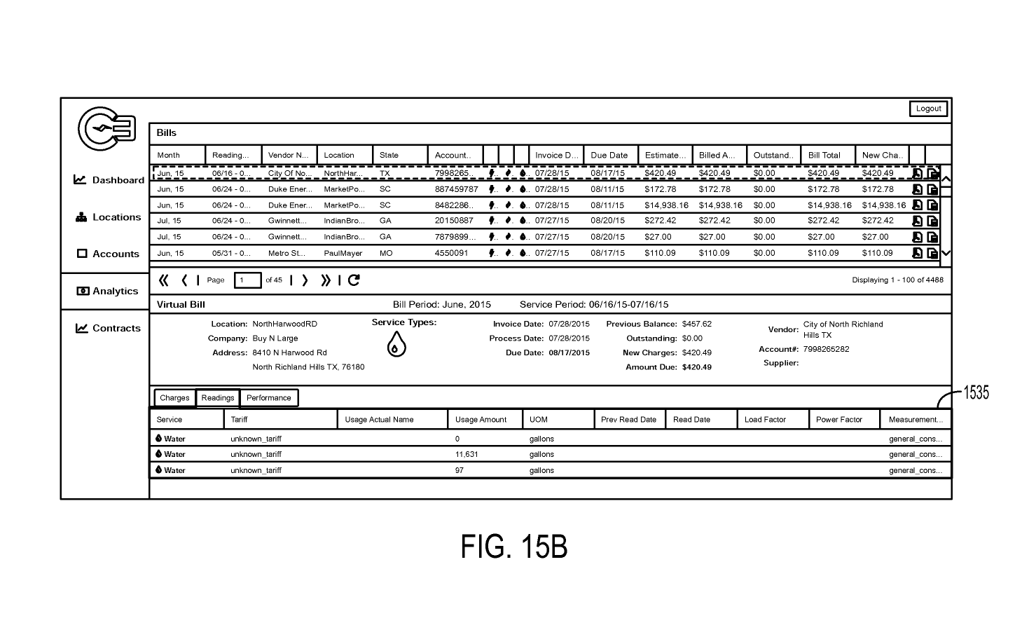

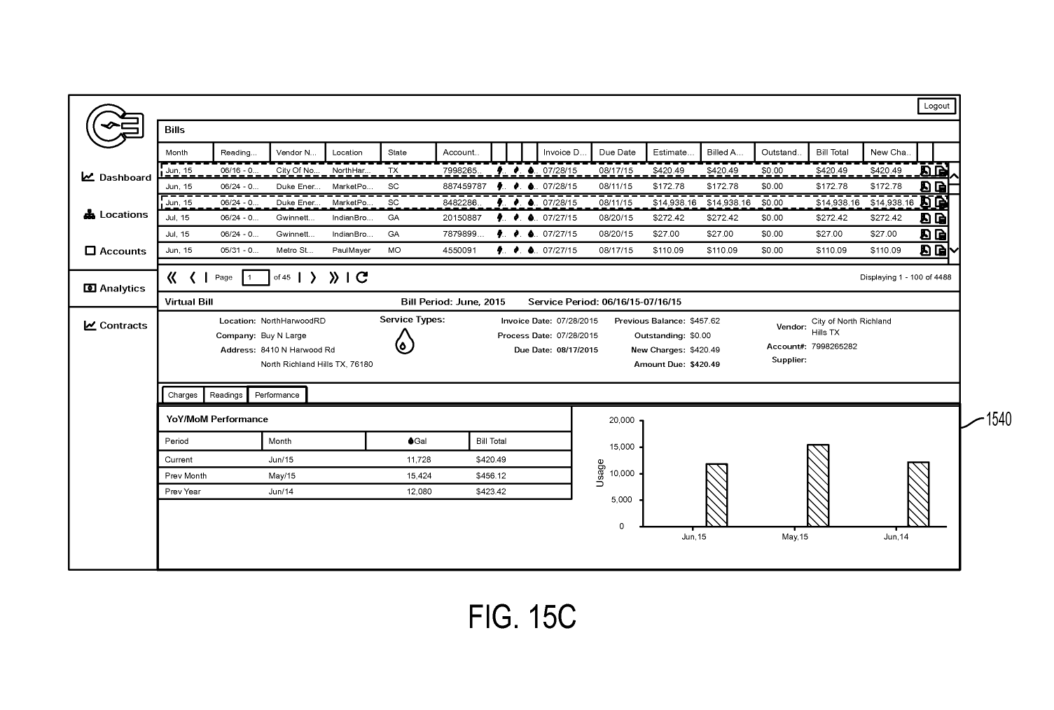

Referring to FIG. 14, the invoice management server 1400 may process 1405 prepared information to create a fourth category of information 1410 that contains actual invoice information (which is 1505 in FIG. 15a) and virtual invoice information (which is 1515 in FIG. 15a). The fourth category of information 1410 may also be created reviewing and retrieving relevant information from the second and/or third category of information. The fourth category of information 1410 may likewise be created by processing prepared information and by reviewing and retrieving relevant information from the second and/or third category of information. The fourth category information may include, as shown in FIG. 15a in a detailed breakdown, multiple pieces of information such as invoice information 1505 from the customer's actual invoices of some or all of the customer's locations, the customer's actual invoices 1510 of some or all of the customer's locations 1510, and virtual invoices 1515. The virtual invoices 1515 may contain some information extracted from the invoice information 1505. Preferably, the extracted information (or virtual invoice information) may include the name of the customer, the name of the customer's location, the address of the customer's location, the invoice date, the process date, the due date, the previous balance, the outstanding balance, the new charges, the amount due, the name of the vendor, and the account number, or any combinations thereof. These information may be collectively referred to as “key information” 1520. For invoice information 1505 that contains two or more energy commodities, the invoice information for each energy commodity may be separated and the virtual invoice information may be extracted from each separated invoice information.

The extracted information (or virtual invoice information) may further include itemized charges. Itemized charges are obtained by reviewing the invoice information and by breaking down the invoice information or the total invoice amount in the invoice information into individual charges. Each individual charge may be a line item charge appears on an actual invoice. Each itemized charge may be identified by name of the charge, rate of the tariff, charge category (e.g., rider, commodity, tax, etc.), energy type, spending amount, usage quantity, unit of measurement, and energy rate, or any combinations thereof. These charges may be collectively referred to as “detail information” 1525.

The fourth category of information or the invoice management server may be configured to have a Key Performance Indicator (KPI) feature 1530 that measures each itemized charge in a performance metric. The KPI feature may allow a customer to enter a performance metric, such as number of days, number of employees, square footage, or any other metric that the customer wants to measure, and the KPI feature divides each itemized charge with the entered metric. The resulting quotient provides an instantaneous and dynamic evaluation of each itemized charge. The customer may know the energy cost per square foot, the energy cost per day, the energy cost per employee, and other information depending on what the itemized charge is and what performance metric the customer has entered.

The extracted information may further include meter reading information 1535. Meter reading information may comprise, as shown in FIG. 15b, previous and current actual meter readings, the difference between previous and current actual meter readings, the energy associated with meter reading, previous and next meter reading date, unit of measurements, and any other meter reading related information.

The extracted information may further include performance information 1540. Performance information may comprise, as shown in FIG. 15c, month-to-month comparison, year-to-year comparison, or both comparisons. In month-to-month comparison, it may compare a month of an year to the same month of another year. In year-to-year comparison, it may compare one year to another year. The information being compared in either comparison may be the amount of energy used or the invoiced total.

In a preferred embodiment, virtual invoice information containing the same extracted information are obtained from each of all of the customer's actual invoices or from the invoice information in each of all of the customer's actual invoices. As such, the virtual invoice standardizes all of the customer's actual invoices into the same format for a quick easy read. The virtual invoice also filters all of the customer's actual invoices to retrieve only important information so that the amount of data need to be processed and saved on the invoice management server are reduced and the hardware and software requirements of the invoice management server may be relaxed.

Although embodiments of the present invention illustrate creating four categories of information, there may be more or less than four categories of information depending on the need of customers and the design of the invoice management server.

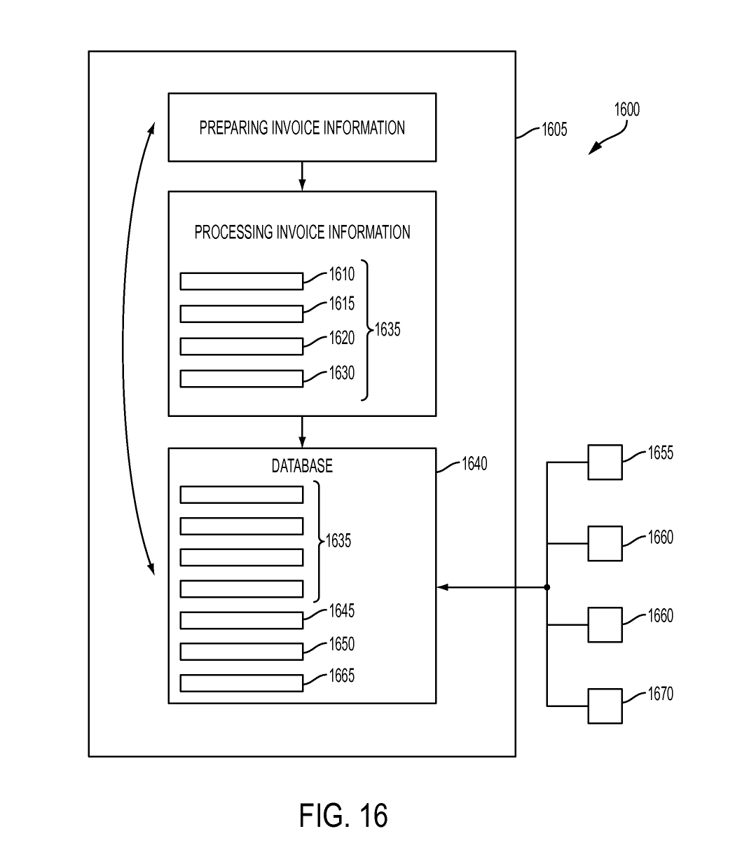

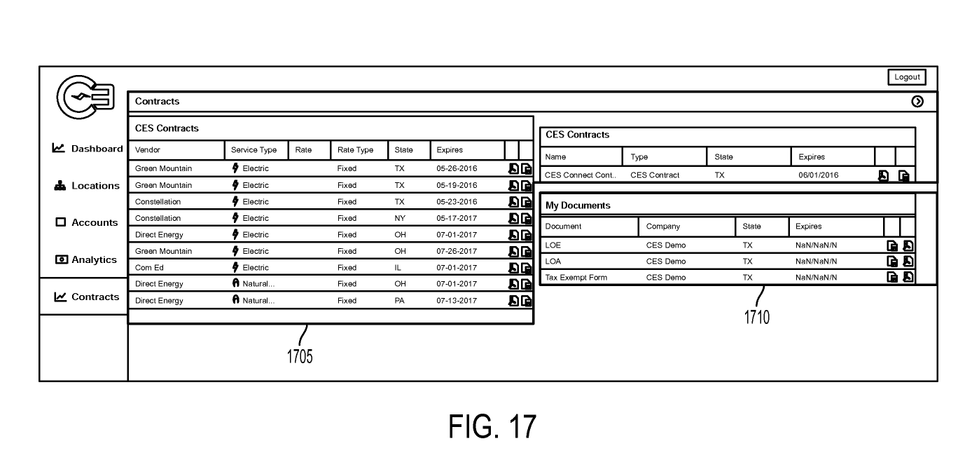

Referring to FIG. 16, one embodiment of the step of storing invoice information 1600 is illustrated. In this embodiment, the invoice management server 1605 may store 1608 all of the categories of information 1635 (where 1610 represents the first category, 1615 represents the second category, 1620 represents the third category, and 1630 represents the fourth category of information) created in the processing step 1610 in a database 1640 in the invoice management server 1605. The invoice management server 1605 may also store prepared information in a the database 1640 before prepared information is processed. The invoice management server 1605 may retrieve that stored prepared information at a later time for processing. The invoice management server 1605 may further store energy service contracts 1645 and other relevant energy management documents 1650 in the database 1640. Such documents may be obtained from a data collecting server 1655 or vendor servers 1660. The customer, via its computer 1670, may access and retrieve those documents from the invoice management server 1605. The customer may also upload its own documents 1665 onto the invoice management server 1605. FIG. 17 is an example screen showing a customer's energy service contracts 1705 and customer uploaded documents 1710 when the customer logs into the invoice management server to view its documents.

The invoice management server may be configured to prepare information needed for energy star certification and/or to apply for star certification for each of the customer's locations. The invoice management server may obtain some of the information required for energy star certification from the prepared information and allow the customer to enter the remaining information. Once the invoice management server receives all the necessary information, the invoice management server may submit those information to the server responsible for processing energy star certification applications. The invoice management server may keep track of each energy star certification process and notify the customer when the invoice management server receives a certification result. The invoice management server may also be configured to have other customer-defined functions relevant to utilities and buildings.

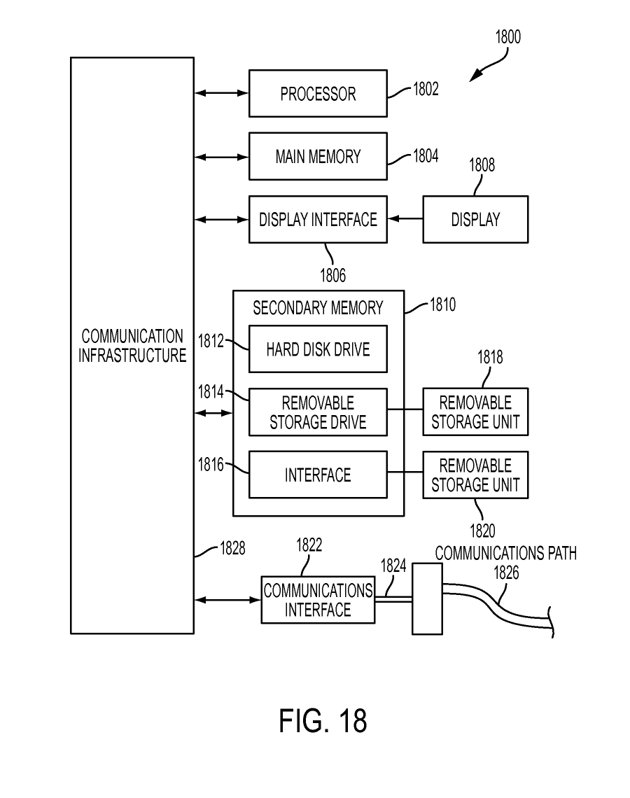

Referring to FIG. 18, exemplary hardware and software components of computer 1800 employed in embodiments of the present invention are shown and will described in detail. Although FIG. 18 illustrates only one computer performing invoice management server functions and/or data collecting server functions, embodiments of the present invention may employ additional computers to perform such functions if necessary. FIG. 18 depicts one embodiment of computer 1800 that comprises a processor 1802, a main memory 1804, a display interface 1806, display 1808, a second memory 1810 including a hard disk drive 1812, a removable storage drive 1814, interface 1816, and/or removable storage units 1818, 1820, a communications interface 1822 providing carrier signals 1824, a communications path 1826, and/or a communication infrastructure 1828.

In one embodiment, computer 1800, such as a server, may not include a display, at least not just for that server, and may have transient and non-transient memory such as RAM, ROM, and hard drive, but may not have removable storage. Computer 1800 may be an invoice management server, a data collecting server, or a server performing functions of both servers. Other configuration of a server may also be contemplated.

Processor or processing circuitry 1802 is operative to control the operations and performance of computer 1800. For example, processor 1802 can be used to run operating system applications, firmware applications, or other applications used to communicate with a data collecting server, vendor servers, and third-party databases. Processor 1802 is connected to communication infrastructure 1828, and via communication infrastructure 1828, processor 1802 can retrieve and store data in the main memory 1804 and/or secondary memory 1810, drive display 1808 and process inputs received from display 1808 (if it is a touch screen) via display interface 1806, and communicate with other, e.g., transmit and receive data from and to, other computers.

The display interface 1806 may be display driver circuitry, circuitry for driving display drivers, circuitry that forwards graphics, texts, and other data from communication infrastructure 1828 for display on display 1808, or any combination thereof. The circuitry can be operative to display content, e.g., application screens for applications implemented on the computer 1800, information regarding ongoing communications operations, information regarding incoming communications requests, information regarding outgoing communications requests, or device operation screens under the direction of processor 1802. Alternatively, the circuitry can be operative to provide instructions to a remote display.

Main memory 1804 may include cache memory, semi-permanent memory such as random access memory (“RAM”), and/or one or more types of memory used for temporarily storing data. Preferably, main memory 1804 is RAM. Secondary memory 1810 may include, for example, hard disk drive 1812, removable storage drive 1814, and interface 1816. Hard disk drive 1812 and removable storage drive 1814 may include one or more tangible computer storage devices such as a hard-drive, solid state drive, flash memory, permanent memory (e.g., ROM), magnetic, optical, semiconductor, or any other suitable type of storage component, or any combination thereof. Either main memory 1804 or second memory 1810 can store, for example, data for implementing functions on computer 1800, authentication information such as libraries of data associated with authorized users, evaluation results, certification results, auditing reports, and exception reports, wireless connection data that can enable computer 1800 to establish a wireless connection, and any other suitable data or any combination thereof. Either main memory 1804 or second memory 1810 can also store, for example, prepared information, processed information or categories of information, algorithms executed by the invoice management server, information from a data collecting server, information from vendor servers, information from third-party databases, energy service contracts, and/or documents uploaded by a customer. The instructions for implementing the functions of the embodiments of the present invention may, as non-limiting examples, comprise non transient software and/or scripts stored in second memory 1810. The storage medium and the database of the invoice management server may be either main memory 1804 or secondary memory 1810, preferably secondary memory 1810.

Removable storage drive 1814 reads from and writes to a removable storage unit 1818 in a well-known manner. Removable storage unit 1818 may be read by and written to removable storage drive 1814. As will be appreciated by the skilled artisan, removable storage unit 1818 includes a computer usable storage medium having stored therein computer software and/or data. Removable storage is option is not typically include as part of a server.

In alternative embodiments, secondary memory 1810 may include other similar devices for allowing computer programs or other instructions to be loaded into computer 1800. Such devices may include for example a removable storage unit 1820 and interface 1816. Examples of such may include a program cartridge and cartridge interface, a removable memory chip (such as an erasable programmable read only memory (“EPROM”), or programmable read only memory (“PROM”) and associated socket, and other removable storage units 1820 and interfaces 1816, which allow software and data to be transferred from the removable storage unit 1820 to computer 1800.

Communications interface 1822 allows software and data to be transferred between computers, systems, and external devices. Examples of communications interface 1822 may include a modem, a network interface such as an Ethernet card, or a communications port, software and data transferred via communications interface 1822 are in the form of signals 1824, which may be electronic, electromagnetic, optical or other signals capable of being received by communications interface 1822. These signals 1824 are provided to communications interface 1822 via a communications path (e.g., channel) 1826. This path 1826 carries signals 1824 and may be implemented using wire or cable, fiber optics, a telephone line, a cellular link, a radio frequency (“RF”) link and/or other communications channels. As used herein, the terms “computer program medium” and “computer usable medium” generally refer to media such as transient or non-transient memory including for example removable storage drive 1814 and hard disk installed in hard disk drive 1812. These computer program products provide software to the computer 1800.

Communication infrastructure 1828 may be a communications-bus, cross-over bar, a network, or other suitable communications circuitry operative to connect to a network and to transmit communications between processor 1802, main memory 1804, display interface 1806, second memory 1810, and communications interface, and between computer 1800 or a system and other computers or systems. When the communication infrastructure 1828 is a communications circuitry operative to connect to a network, the connection may be established by a suitable communications protocol. The connection may also be established by using wires such as an optical fiber or Ethernet cable.

Computer programs also referred to as software, software application, or computer control logic are stored in main memory 1804 and/or secondary memory 1810. Computer programs may also be received via communications interface 1822. Such computer programs, when executed, enable or configure the computer 1800 to perform the features of the present invention as discussed herein. In particular, the computer programs, when executed, enable the processor 1802 to perform the features of the present invention. Accordingly, such computer programs represent controllers of the computer 1800.

In an embodiment in which the invention is implemented using software, the software may be stored in a computer program product and loaded into computer 1800 using removable storage drive 1814, hard drive 1812, or communications interface 1822. The control logic, which is the software when executed by processor 1802 causes processor 1802 to perform the feature of the invention as described herein.

In another embodiment, the invention is implemented primarily in hardware using for example hardware components, such as application specific integrated circuits (“ASICs”). Implementation of the hardware state machine so as to perform the functions described herein will be apparent to persons skilled in the relevant arts.

In yet another embodiment, the embodiments of the instant invention are implemented using a combination of both hardware and software.

Computer 1800 may also include input peripherals for use by customers to interact with and input information into computer 1800. Customers can use a computer or computer-based devices such as their PC or mobile phones to access and interact with the created categories of information and/or stored documents such as using a browser or other software application running on the computer or computer-based device to the computer 1800 or the invoice management server. Computer 1800 can also be a database server for storing and maintaining a database. It is understood that it can contain a plurality of databases in the memory (in main memory 1804, in secondary memory 1810, or both). In some embodiments, a server can comprise at least one computer acting as a server as would be known in the art. The server(s) can be a plurality of the above mentioned computer or electronic components and devices operating as a virtual server, or a larger server operating as a virtual server which may be a virtual machine, as would be known to those of ordinary skill in the art. Such possible arrangements of computer(s), distributed resources, and virtual machines can be referred to as a server or server system. Cloud computing, for example, is also contemplated. As such, functions of or steps performed by the invoice management server can be implemented on a separate servers, same server, or different types of computers. Each function of or each step performed by the invoice management server can also be implemented on a virtual server that may be part of a server system that provides one or more virtual servers.

The present servers, methods, or related inventions also relate to a non-transient computer readable medium configured to carry out any one of the methods disclosed herein. The steps can be a set of instructions readable by a processor and stored on the non-transient computer readable medium. Such medium may be permanent or semi-permanent memory such as hard drive, floppy drive, optical disk, flash memory, ROM, EPROM, EEPROM, etc., as would be known to those of ordinary skill in the art.

Embodiments of the present invention illustrate an invoice management server that may be utilized by one or more customers or be accessed by one or more of customer computers. Example screens are some screens that a customer may see when the customers logs into the invoice management server. The invoice management server may perform the processing step and the storing step in any order after the preparing step. In a preferred embodiment, the invoice management server is configured without any invoice payment capabilities.

While some embodiments of the present invention are described with respect to managing utility invoices and information contained therein, it should be noted that those embodiments, and other embodiments, of the present invention may also manage other commodity invoices, periodic invoices, one-time invoices, and information contained in those invoices.

Benefits provided by embodiments of the present invention include saving customers' time, eliminating human errors, and provide financial and operational efficiencies.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A system for managing invoice information comprising:
an invoice management server comprising a processor and a memory storing a series of instructions, wherein the processor is configured to execute the series of instructions to:
prepare invoice information by instructing the invoice management server to communicate with a data collecting server to receive aggregated and standardized invoice information of a customer from the data collecting server, the data collecting server aggregating and standardizing invoice information of the customer from multiple vendor servers;
process invoice information by instructing the invoice management server to process prepared invoice information into categories of information, wherein the categories of information include a first category of information containing the customer's energy spending summary, a second category of information containing invoice information based on the customer's locations, a third category of information containing invoice information based on the customer's accounts, and a fourth category of information containing actual invoice information and virtual invoice information, wherein the virtual invoice information contains information extracted from the actual invoice information and the extracted information includes itemized charges; and
store invoice information by instructing the invoice management server to store prepared invoice information, processed information, information from vendor servers, and documents uploaded by the customer.

2. The system according to claim 1, wherein the customer's energy spending summary is created based on energy type, vendor, and historical spending.

3. The system according to claim 2, wherein the customer's energy spending summary created based on energy type include multiple pieces of information that comprise an energy type piece of information.

4. The system according to claim 3, wherein the energy type piece of information is created before remaining pieces of information in the multiple pieces of information.

5. The system according to claim 2, wherein the customer's energy spending summary created based on vendor include multiple pieces of information that comprise a list of vendors.

6. The system according to claim 5, wherein the list of vendors is created before remaining pieces of information in the multiple pieces of information.

7. The system according to claim 2, wherein the customer's energy spending summary created based on historical spending include multiple pieces of information that comprise amounts the customer has paid, one or more energy type being paid, period of time the customer has been paying, and frequency of the payment.

8. The system according to claim 7, wherein the one or more energy type being paid piece of information or the period of time piece of information is created before remaining pieces of information in the multiple pieces of information.

9. The system according to claim 1, wherein the second category of information include multiple pieces of information that comprise a list of all the customer's locations.

10. The system according to claim 9, wherein the list of all the customer's locations is created before remaining pieces of information in the multiple pieces of information.

11. The system according to claim 1, wherein the third category of information include multiple pieces of information that comprise a list of all the customer's accounts.

12. The system according to claim 11, wherein the list of all the customer's accounts is created before remaining pieces of information in the multiple pieces of information.

13. The system according to claim 1, wherein the itemized charges are individual charges obtained by breaking down a total invoice amount in the actual invoice information.

14. The system according to claim 13, wherein the processor is configured to execute the series of instructions to further measure each itemized charge in a performance metric.

15. The system according to claim 14, wherein the performance metric is customer-entered.

16. The system according to claim 15, wherein same virtual invoice information are extracted from actual invoices of all the customer's locations.

17. The system according to claim 1, wherein the extracted information further include meter reading information and performance information.

18. The system according to claim 17, wherein the performance information include month-to-month comparison or year-to-year comparison.

19. The system according to claim 1, wherein the processor is configured to execute the series of instructions to further prepare information needed for energy star certification and to apply for energy star certification for each of the customer's locations.

20. A method for managing invoice information comprising:
preparing invoice information by aggregating and standardizing invoice information of a customer from multiple vendor servers;
processing invoice information by process prepared invoice information into categories of information, wherein the categories of information include a first category of information containing the customer's energy spending summary, a second category of information containing invoice information based on the customer's locations, a third category of information containing invoice information based on the customer's accounts, and a fourth category of information containing actual invoice information and virtual invoice information, wherein the virtual invoice information contains information extracted from the actual invoice information and the extracted information includes itemized charges; and
storing invoice information by storing prepared invoice information, processed information, information from vendor servers, and documents uploaded by the customer.
